(19) United States
(12) Patent Application Publication
(10) Pub. No.: US 2026/0155095 A1
(43) Pub. Date: Jun. 4, 2026

(54) DISPLAY PANEL AND DISPLAY DEVICE

(71) Applicant: Tianma Advanced Display Technology Institute (Xiamen) Co., Ltd., Xiamen (CN)

(72) Inventors: Xueling LI, Xiamen (CN); Zhenyu JIA, Xiamen (CN)

(73) Assignee: Tianma Advanced Display Technology Institute (Xiamen) Co., Ltd., Xiamen (CN)

(21) Appl. No.: 19/396,388

(22) Filed: Nov. 21, 2025

(30) Foreign Application Priority Data
Nov. 29, 2024 (CN) 202411745901.3

(51) Int. Cl. G09G 3/32

(52) U.S. Cl. CPC G09G 3/32; G09G 2300/0426; G09G 2300/0852; G09G 2300/0861; G09G 2330/04

(57) ABSTRACT

Embodiments of the present application provide a display panel and a display device. The display panel comprises: a circuit unit comprising M pixel circuits arranged in a first direction, M being an integer greater than or equal to 2; data lines comprising first data lines and second data lines, the pixel circuit being electrically connected to the first data line and the second data line, wherein the data lines adjacent to each other in the first direction and not separated by pixel circuits comprise at most M-1 first data lines electrically connected to the same circuit unit, and/or at most M-1 second data lines electrically connected to the same circuit unit; or at each of opposite sides of at least one pixel circuit in the first direction, the first data line and second data line electrically connected to the circuit unit on which the pixel circuit is located are disposed.

### CROSS-REFERENCE TO RELATED APPLICATIONS

This application claims priority to Chinese Patent Application No. 202411745901.3, filed on Nov. 29, 2024, which is hereby incorporated by reference in its entirety.

### TECHNICAL FIELD

The present application relates to the technical field of display, and in particular to a display panel and a display device.

### BACKGROUND

To improve display effects, currently, display panels can be driven by combining pulse amplitude modulation (PAM) and pulse width modulation (PWM).

### SUMMARY

Embodiments of the present application provide a display panel and a display device.

In a first aspect, embodiments of the present application provide a display panel comprising: circuit units, a circuit unit of the circuit units comprising M pixel circuits arranged in a first direction, M is an integer greater than or equal to 2; and data lines, comprising first data lines and second data lines, the pixel circuits being electrically connected to the data lines, wherein the data lines adjacent to each other in the first direction and not separated by any one of the pixel circuits comprise at most M-1 first data lines electrically connected to the circuit unit, and/or at most M-1 second data lines electrically connected to the circuit unit; or at both of two opposite sides of at least one of the pixel circuits in the first direction, at least one of the first data lines electrically connected to the circuit unit in which the at least one pixel circuit is located and at least one of the second data lines electrically connected to the circuit unit in which the at least one pixel circuit is located are disposed.

In a second aspect, based on the same inventive concept, embodiments of the present application provide a display device comprising the above-mentioned display panel.

### BRIEF DESCRIPTION OF THE DRAWINGS

In order to more clearly illustrate the embodiments of the present application or the technical solutions in the prior art, the following is a brief introduction to the drawings required for use in the embodiments or the description of the prior art. Obviously, the drawings described below are some embodiments of the present application. For those skilled in the art, other drawings can be obtained based on these drawings without paying any creative labor.

FIG. 1 is a schematic structural diagram of a display panel in the related art;

FIG. 2A is a schematic structural diagram of a display panel provided in an embodiment of the present application;

FIG. 2B is a schematic structural diagram of a display panel provided in another embodiment of the present application;

FIG. 3A is a schematic structural diagram of a display panel provided in yet another embodiment of the present application;

FIG. 3B is a schematic structural diagram of a display panel provided in yet another embodiment of the present application;

FIG. 4A is a schematic structural diagram of a display panel provided in yet another embodiment of the present application;

FIG. 4B is a schematic structural diagram of a display panel provided in yet another embodiment of the present application;

FIG. 5A is a schematic structural diagram of a display panel provided in yet another embodiment of the present application;

FIG. 5B is a schematic structural diagram of a display panel provided in yet another embodiment of the present application;

FIG. 6A is a schematic structural diagram of a display panel provided in yet another embodiment of the present application;

FIG. 6B is a schematic structural diagram of a display panel provided in yet another embodiment of the present application;

FIG. 7 is a schematic structural diagram of a display panel provided in yet another embodiment of the present application;

FIG. 8 is a schematic structural diagram of a display panel provided in yet another embodiment of the present application;

FIG. 9 is a schematic structural diagram of a display panel provided in yet another embodiment of the present application;

FIG. 10 is a schematic structural diagram of a display panel provided in yet another embodiment of the present application;

FIG. 11 is a schematic structural diagram of a display panel provided in yet another embodiment of the present application;

FIG. 12 is a schematic structural diagram of a display panel provided in yet another embodiment of the present application;

FIG. 13 is a schematic structural diagram of a display panel provided in yet another embodiment of the present application;

FIG. 14 is a schematic structural diagram of a display panel provided in yet another embodiment of the present application;

FIG. 15 is a schematic structural diagram of a display panel provided in yet another embodiment of the present application;

FIG. 16 is a schematic structural diagram of a display panel provided in yet another embodiment of the present application;

FIG. 17 is a schematic diagram of a circuit structure of a first electrostatic protection circuit provided in an embodiment of the present application;

FIG. 18 is a schematic diagram of a circuit structure of a second electrostatic protection circuit provided in an embodiment of the present application;

FIG. 19 is a schematic diagram of a circuit structure of a pixel circuit provided in an embodiment of the present application; and

FIG. 20 is a schematic structural diagram of a display device provided in an embodiment of the present application.

### DETAILED DESCRIPTION

In order to better understand the technical solution of the present application, the embodiments of the present application are described in detail below with reference to the accompanying drawings.

It should be understood that the embodiments described are only a part of the embodiments of the present application, not all of the embodiments. Based on the embodiments of the present application, all other embodiments obtained by those of ordinary skilled in the art without creative work are within the scope of protection of the present application.

The terms used in the embodiments of the present application are only for the purpose of describing specific embodiments and are not intended to limit the present application. The singular forms "a", "an", and "the" used in the embodiments of the present application and the appended claims are also intended to comprise plural forms unless the context clearly indicates otherwise.

It should be understood that the term "and/or" as used herein is merely a description of the relationship between associated objects, indicating that three possible relationships exist. For example, "A and/or B" can represent: A exists alone, A and B exist simultaneously, or B exists alone. Furthermore, the character "/" in this document generally indicates that the associated objects are in an "or" relationship.

As described in the background, current display panels can be driven by a driving method that combines PAM and PWM.

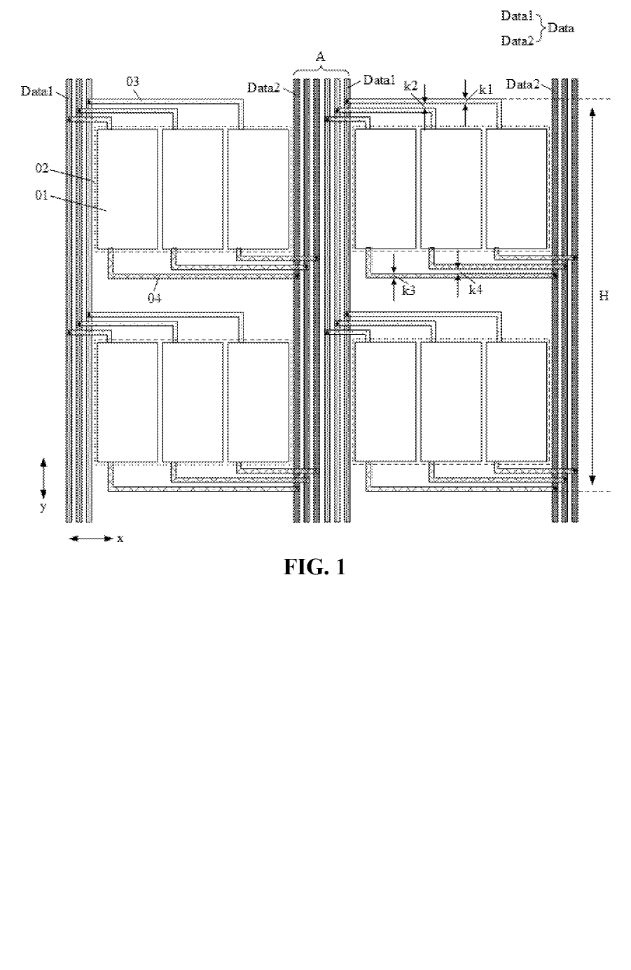

As shown in FIG. 1, which is a schematic structural diagram of a display panel in the related art. The data lines Data in this type of display panel comprise a first data line Data1 and a second data line Data2. One of the first data line Data1 and the second data line Data2 is for transmitting the PAM data voltage required for PAM driving, and the other is for transmitting the PWM data voltage required for PWM driving.

A pixel circuit 01 is electrically connected to the first data line Data1 through a first connecting line 03, and is electrically connected to the second data line Data2 through a second connecting line 04.

In the related art, the first data line Data1 connected to M pixel circuits 01 in a circuit unit 02 is usually provided at a side of the circuit unit 02 in the first direction x, and the first data line Data1 connected to the M pixel circuits 01 in the circuit unit 02 is provided at the other side of the circuit unit 02 in the first direction x, where M is an integer greater than or equal to 2.

However, the inventors discovered during research that, based on this arrangement of the data lines Data, the circuit unit 02 requires relatively large wiring spaces on both sides thereof in the second direction y, resulting in a relatively large vertical height of pixels.

The following takes an example that the first data line Data1 connected to the M pixel circuits 01 in the circuit unit 02 is located on the left side of the circuit unit 02 and the second data line Data2 connected to the M pixel circuits 01 is located on the right side of the circuit unit 02.

In this arrangement, M first connecting lines 03 corresponding to M pixel circuits 01 in the circuit unit 02 all require to turn leftward above the circuit unit 02 to connect to the first data line Data1. This causes the M first connecting lines 03 to overlap with each other in the second direction y, resulting in the M first connecting lines 03 occupying at least M × (k1+k2) of the vertical height above the circuit unit 02, where k1 is the line width of the first connecting line 03, and k2 is the clearance distance between the first connecting line 03 and other wiring in the second direction y and can also be understood as the spacing between two adjacent first connecting lines 03 in the second direction y.

Similarly, in the circuit unit 02, M second connecting lines 04 corresponding to the M pixel circuits 01 all require to turn rightward below the circuit unit 02 to connect to the second data line Data2. This causes M second connecting lines 04 to overlap with each other in the second direction y, resulting in M second connecting lines 04 occupying at least M × (k3+k4) of the vertical height below the circuit unit 02. k3 is the line width of the second connecting line 04, and k4 is the clearance distance between the second connecting line 04 and other wiring in the second direction y and can also be understood as the spacing between two adjacent second connecting lines 04 in the second direction y, where k3 and k1 may be equal or unequal, and k4 and k2 may be equal or unequal.

Furthermore, the vertical height H of the pixel is relatively large, which is not conducive to the optimization of PPI.

In view of this, embodiments of the present application provide a display panel, which can be a light emitting diode (LED) or other type of display panel such as a micro LED display panel.

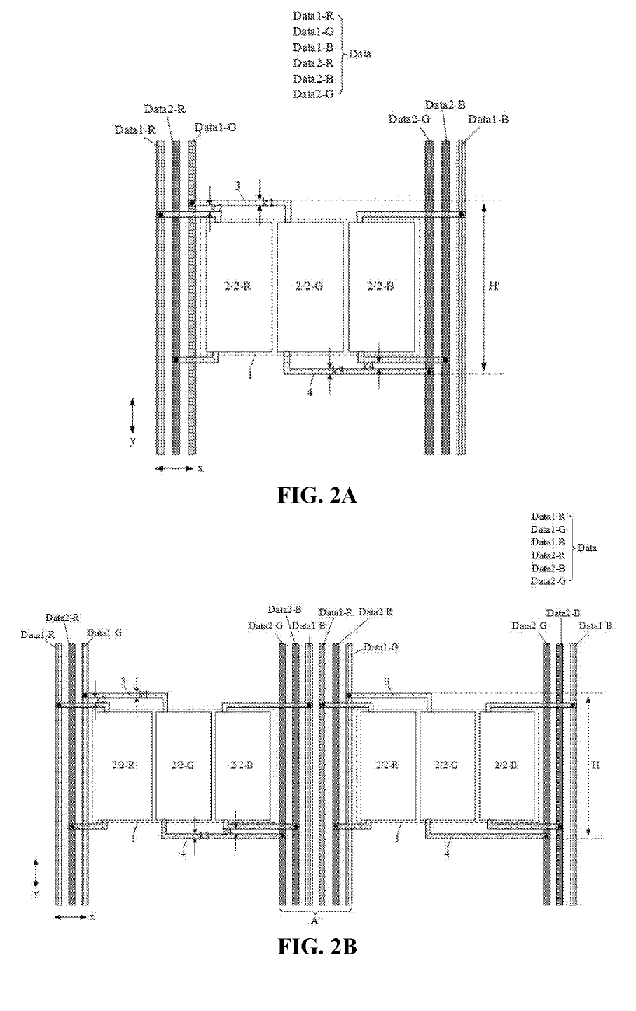

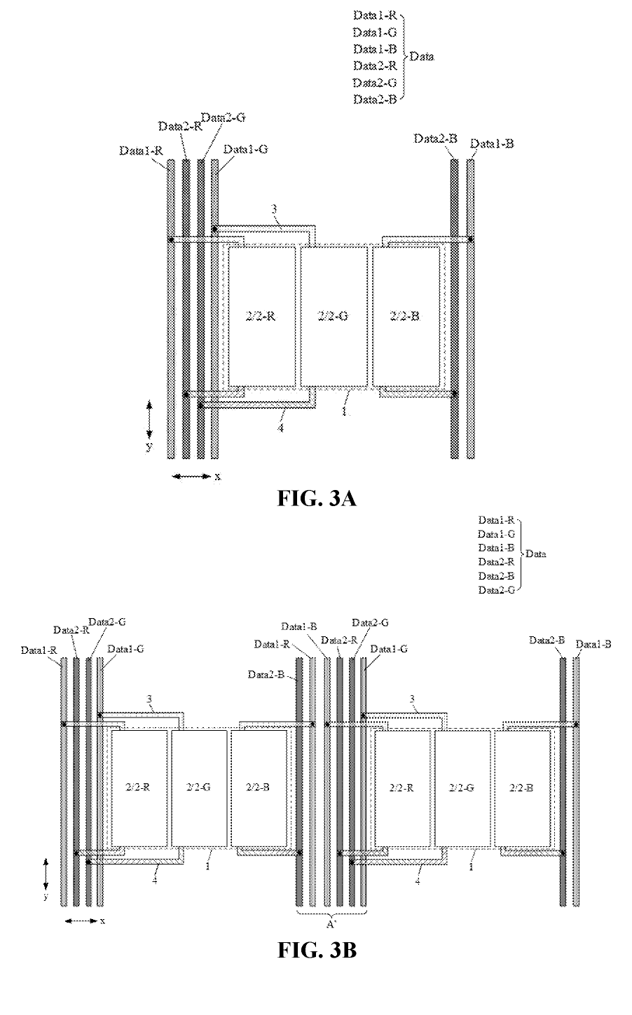

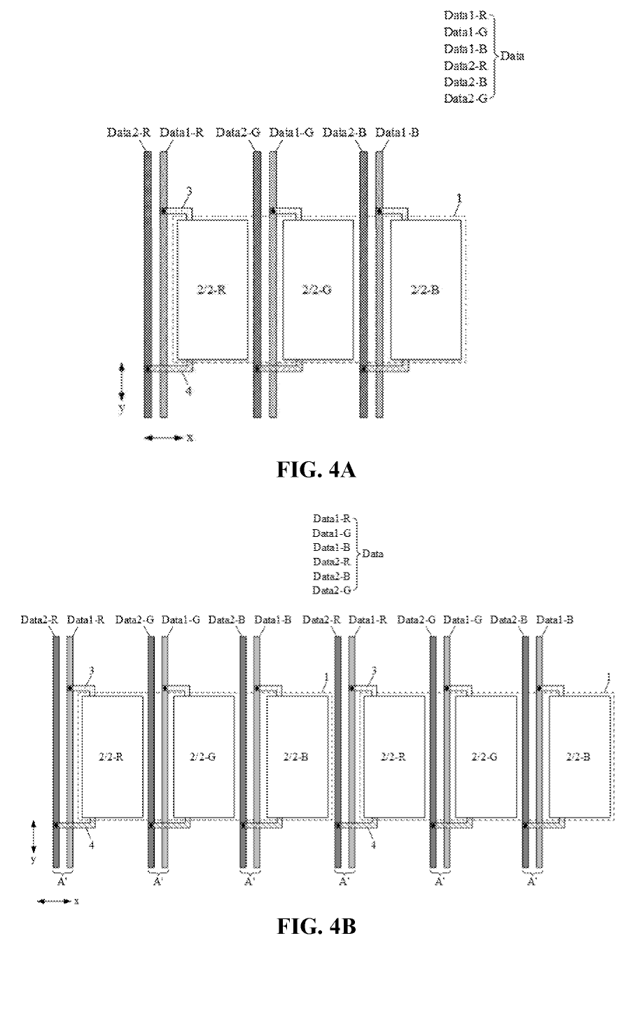

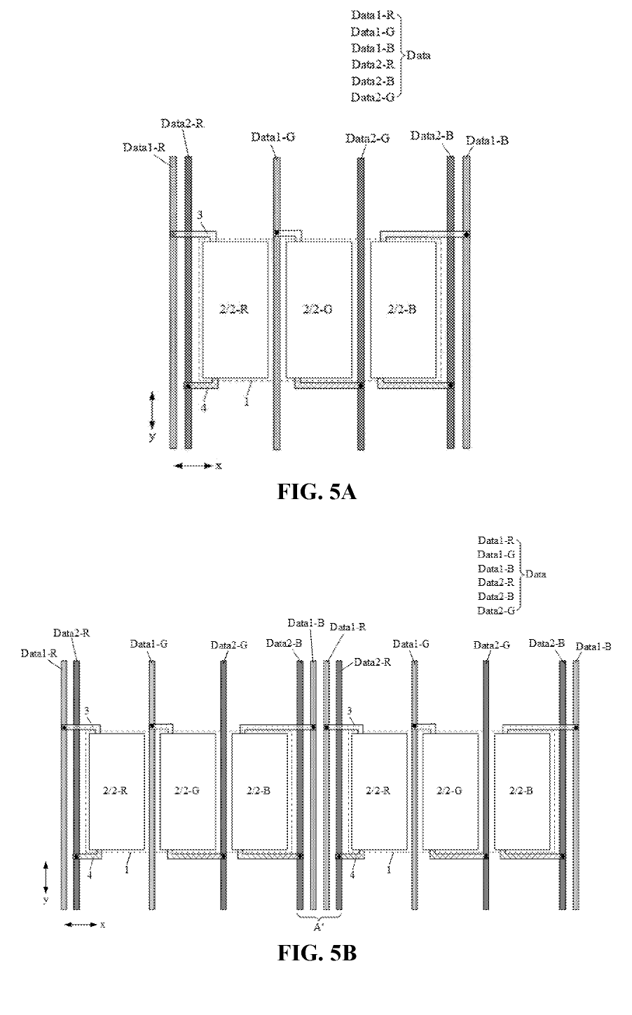

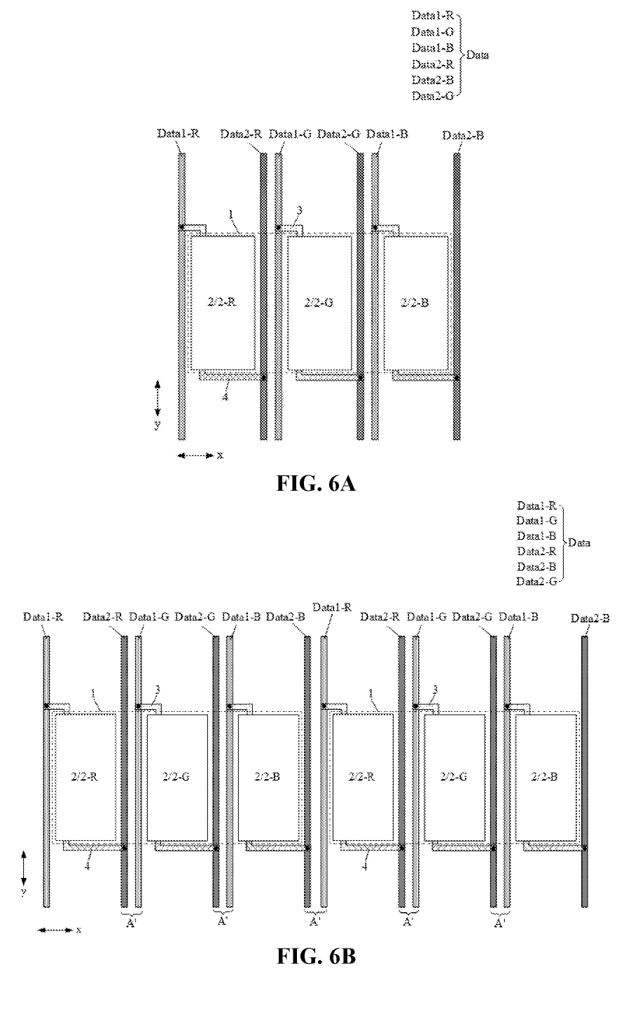

As shown in FIGS. 2A-6B, FIG. 2A is a schematic structural diagram of a display panel provided in an embodiment of the present application; FIG. 2B is a schematic structural diagram of a display panel provided in another embodiment of the present application; FIG. 3A is a schematic structural diagram of a display panel provided in yet another embodiment of the present application; FIG. 3B is a schematic structural diagram of a display panel provided in yet another embodiment of the present application; FIG. 4A is a schematic structural diagram of a display panel provided in yet another embodiment of the present application; FIG. 4B is a schematic structural diagram of a display panel provided in yet another embodiment of the present application; FIG. 5A is a schematic structural diagram of a display panel provided in yet another embodiment of the present application; FIG. 5B is a schematic structural diagram of a display panel provided in yet another embodiment of the present application; FIG. 6A is a schematic structural diagram of a display panel provided in yet another embodiment of the present application; and FIG. 6B is a schematic structural diagram of a display panel provided in yet another embodiment of the present application.

The display panel comprises a circuit unit 1, and the circuit unit 1 comprises M pixel circuits 2 arranged in a first direction x, where M is an integer greater than or equal to 2.

The display panel further comprises data lines Data, which comprise a first data line Data1 and a second data line Data2. The pixel circuit 2 is electrically connected to the first data line Data1 and the second data line Data2, respectively. More specifically, the pixel circuit 2 is electrically connected to the first data line Data1 through a first connecting line 3 and to the second data line Data2 through a second connecting line 4.

The data lines Data adjacent to each other in the first direction x and not separated by pixel circuits 2 comprise at most M-1 first data lines Data1 electrically connected to the same circuit unit 1 and/or at most M-1 second data lines Data2 electrically connected to the same circuit unit 1.

Alternatively, two opposite sides of at least one pixel circuit 2 in the first direction x each are provided with a first data line Data1 and a second data line Data2 electrically connected to the circuit unit 1 on which the pixel circuit 2 is located.

Regarding “the data lines Data adjacent to each other in the first direction x and not separated by pixel circuits 2 comprise at most M-1 first data lines Data1 electrically connected to the same circuit unit 1 and/or at most M-1 second data lines Data2 electrically connected to the same circuit unit 1”, the data lines Data adjacent to each other in the first direction x and not separated by pixel circuits 2 are defined as a data line group.

In the related art, referring to FIG. 1, the display panel comprises a data line group A, which comprises M first data lines Data1 electrically connected to the same circuit unit 1, and M second data lines Data2 electrically connected to the same circuit unit 1.

This arrangement allows M first connecting lines 03 to overlap with each other above the circuit unit 02 in the second direction y, occupying at least M × (k1+k2) of a vertical height, and allows M second connecting lines 04 to overlap with each other below the circuit unit 02, occupying at least M × (k3+k4) of a vertical height.

In the embodiments of the present application, referring to FIGS. 2B, 3B, 4B, 5B and 6B, the display panel comprises a data line group A’, and the data line group A’ comprises at most M-1 first data lines Data1 electrically connected to the same circuit unit 1, and/or, at most M-1 second data lines Data2 electrically connected to the same circuit unit 1.

In this arrangement, above the circuit unit 1, at most only M-1 first connecting lines 3 corresponding to M-1 pixel circuits 2 need to turn leftward to the data line group A’ and electrically connect to the first data line Data1, while the first connecting line 3 corresponding to the remaining pixel circuit 2 turns rightward to electrically connect to the first data line Data1. In this way, at most only M-1 first connecting lines 3 overlap in the second direction y, and M first connecting lines 3 occupy at most (M-1) × (k1+k2) of a vertical height above the circuit unit 1. Additionally or alternatively, below the circuit unit 1, at most only M-1 second connecting lines 4 corresponding to M-1 pixel circuits 2 need to turn rightward to the data line group A’ and electrically connect to the second data line Data2, while the second connecting line 4 corresponding to the remaining pixel circuit 2 turns leftward to electrically connect to the second data line Data2. In this way, at most only M-1 second connecting lines 4 overlap in the second direction y, and M second connecting lines 4 occupy at most (M-1) × (k3+k4) of a vertical height below the circuit unit 1, where k1, k2, k3 and k4 are marked in FIGS. 2A and 2B.

The upper side and the lower side of the circuit unit 1 may be understood as two opposite sides of the circuit unit 1 in the second direction y.

Regarding “two opposite sides of at least one pixel circuit 2 in the first direction x is provided with a first data line Data1 and a second data line Data2 electrically connected to the circuit unit 1 on which the pixel circuit 2 is located”, first, it should be noted that the pixel circuit 2 comprises a first side and a second side that are opposite to each other in the first direction x. The above feature can be understood as: for at least one pixel circuit 2, a first side area of the pixel circuit 2 is provided with a first data line Data1 and a second data line Data2 electrically connected to the circuit unit 1 on which the pixel circuit 2 is located, and the first data line Data1 and second data line Data2 may be adjacent to or not adjacent to the pixel circuit 2 on this side; and a second side area of the pixel circuit 2 is provided with a first data line Data1 and second data lines Data2 electrically connected to the circuit unit 1 on which the pixel circuit 2 is located, and the first data line Data1 and second data line Data2 may be adjacent to or not adjacent to the pixel circuit 2 on this side.

In the related art, still referring to FIG. 1, at a side of the pixel circuit 2 in the first direction x, only the first data line Data1 electrically connected to the circuit unit 1 on which the pixel circuit 2 is located is provided, or only the second data line Data2 electrically connected to the circuit unit 1 on which the pixel circuit 2 is located is provided.

This arrangement allows M first connecting lines 03 to overlap with each other above the circuit unit 02 in the second direction y, occupying at least M × (k1+k2) of the vertical height, and M second connecting lines 04 to overlap with each other below the circuit unit 02, occupying at least M × (k3+k4) of the vertical height.

In the embodiments of the present application, a first data line Data1 and a second data line Data2 electrically connected to the circuit unit 1 on which the pixel circuit 2 is located are provided at a side of at least one pixel circuit 2, and a first data line Data1 and second data lines Data2 electrically connected to the circuit unit 1 on which the pixel circuit 2 is located are provided at the other side of the pixel circuit 2.

This means M first data lines Data1 connected to the circuit unit 1 are distributed on opposite sides of at least one pixel circuit 2, and M second data lines Data2 connected to the circuit unit 1 are also distributed on opposite sides of the at least one pixel circuit 2.

In M first data lines Data1 connected to the circuit unit 1, some first connecting lines 3 turn leftward to electrically connect to the first data line Data1, while some first connecting lines 3 turn rightward to electrically connect to the first data line Data1. In M second data lines Data2 connected to the circuit unit 1, some second connecting lines 4 turn rightward to electrically connect to the second data line Data2, while some second connecting lines 4 turn leftward to electrically connect to the second data line Data2.

This means that above the circuit unit 1, at most only M-1 first connecting lines 3 corresponding to M-1 pixel circuits 2 may overlap in the second directiony, and the M first connecting lines 3 may occupy at most (M-1) × (k1+k2) of the vertical height above the circuit unit 1. Below the circuit unit 1, at most only M-1 second connecting lines 4 corresponding to M-1 pixel circuits 2 may overlap with each other in the second direction y, and M second connecting lines 4 may only occupy at most (M-1) × (k3+k4) of the vertical height below the circuit unit 1.

As can be seen, in the embodiments of the present application, at least k1+k2 of the vertical height above the circuit unit 1, and/or at least k3+k4 of the vertical height below the circuit unit 1 can be saved. Comparing FIGS. 1 with FIG. 2A, the vertical height H’ of a pixel in the embodiments of the present application is reduced by at least k1+k2+k3+k4 compared to the vertical height H of a pixel in the related art. The saved layout space can be used to accommodate more pixels, thereby effectively improving the PPI of the display panel.

Furthermore, the vertical height of pixels is compressed, which reduces the risk of metal wiring damage when laser cutting is required at the edges of the display panel during the manufacturing process. Alternatively, in narrow-bezel display panels, pixel circuits at edges need to be inwardly arranged, so the vertical height of the pixels is compressed, which can also increase the design flexibility of the frame width.

In a feasible embodiment, referring to FIGS. 2A-6B, in the first direction x, no other circuit unit 1 is interposed between the data line Data and the circuit unit 1 electrically connected thereto. In other words, the data line Data connected to the pixel circuit 2 in the circuit unit 1 is either located between adjacent pixel circuits 2 in the circuit unit 1, or located at a side of the circuit unit 1 in the first direction x and adjacent to the circuit unit 1.

This arrangement can make the pixel circuit 2 and the data line Data connected thereto relatively close, thereby reducing the connection distance between the two and further reducing signal attenuation.

In a feasible embodiment, referring to FIGS. 2A-4B, in the circuit unit 1, the first data line Data1 electrically connected to at most M-1 pixel circuits 2 is located on a same side of the circuit unit 1 in the first direction x, and may further be adjacent to the circuit unit 1; the second data line Data2 electrically connected to at most M-1 pixel circuits 2 is located on a same side of the circuit unit 1 in the first direction x, and may further be adjacent to the circuit unit 1.

Taking FIGS. 2A and 2B in which M = 2 as an example, in the circuit unit 1, the first data line Data1 connected to two pixel circuits 2 and the second data line Data2 connected to one pixel circuit 2 are located on the left side of the circuit unit 1, and the first data line Data1 connected to one pixel circuit 2 and the second data line Data2 connected to two pixel circuits 2 are located on the right side of the circuit unit 1.

Based on this arrangement, in M first connecting lines 3 connected to the circuit unit 1, at most only M-1 first connecting lines 3 need to turn toward a same side to connect to the first data line Data1, and the vertical height above the circuit unit 1 can be compressed by at least k1+k2. In M second connecting lines 4 connected to the circuit unit 1, at most only M-1 second connecting lines 4 need to turn toward a same side to connect to the second data line Data2, and the vertical height below the circuit unit 1 can be compressed by at least k3+k4.

In a feasible embodiment, referring to FIGS. 2A-5B, two data lines Data electrically connected to at least one pixel circuit 2 are located on a same side of the pixel circuit 2 in the first direction x, and may further be adjacent to the pixel circuit 2.

Therefore, under the premise of compressing the vertical height of pixels, the distance from at least one of the pixel circuits 2 to each of two data lines Data connected thereto is the same, and the load difference between the first connecting line 3 and the second connecting line 4 is relatively small.

Regarding the above-mentioned design of "two data lines Data electrically connected to at least one pixel circuit 2 are located on a same side of the pixel circuit 2 in the first direction x", in a feasible embodiment, referring to FIGS. 2A-6B, the pixel circuit 2 comprises a first pixel circuit 2-R, a second pixel circuit 2-G and a third pixel circuit 2-B.

The first pixel circuit 2-R may be electrically connected to a red light-emitting device, the second pixel circuit 2-G may be electrically connected to a green light-emitting device, and the third pixel circuit 2-B may be electrically connected to a blue light-emitting device.

For ease of distinction, in the drawings of the embodiments of the present application, first data lines connected to the first pixel circuit 2-R, the second pixel circuit 2-G, and the third pixel circuit 2-B are respectively identified by the reference numerals Data1-R, Data1-G, and Data1-B, and second data lines connected to the first pixel circuit 2-R, the second pixel circuit 2-G, and the third pixel circuit 2-B are respectively identified by the reference numerals Data2-R, Data2-G, and Data2-B.

The circuit unit 1 comprises a first pixel circuit 2-R, a second pixel circuit 2-G, and a third pixel circuit 2-B arranged in a first direction x.

Two data lines Data electrically connected to the first pixel circuit 2-R are located at a side of the first pixel circuit 2-R away from the second pixel circuit 2-G, and may further be adjacent to the first pixel circuit 2-R. Additionally or alternatively, two data lines Data electrically connected to the third pixel circuit 2-B are located at a side of the third pixel circuit 2-B away from the second pixel circuit 2-G, and may further be adjacent to the third pixel circuit 2-B.

The first pixel circuit 2-R and the third pixel circuit 2-B are pixel circuits on the outer sides of the circuit unit 1. The first pixel circuit 2-R and the third pixel circuit 2-B each are relatively close to one side of the circuit unit 1 and relatively far from the other side.

Based on the above arrangement, the first pixel circuit 2-R is relatively close to two data lines Data connected thereto, and the third pixel circuit 2-B is relatively close to two data lines Data connected thereto. The connection wiring between these two pixel circuits and the data lines is more convenient and the connection distance is relatively short, and the signal voltage drop is relatively small.

Furthermore, referring to FIGS. 3A and 3B, two data lines Data electrically connected to the second pixel circuit 2-G are located at the same side of the circuit unit 1 in the first direction x.

For example, the first data line Data1-G and the second data line Data2-G are located at a side of the first pixel circuit 2-R away from the second pixel circuit 2-G. Alternatively, the first data line Data1-G and the second data line Data2-G are located at a side of the third pixel circuit 2-B away from the second pixel circuit 2-G.

Comparing FIGS. 1 with FIG. 3B, in this arrangement, the data lines Data are distributed in the spaces between circuit units 1, and 2M data lines are evenly distributed in each space. This data line distribution pattern is consistent with that used in related art. This panel structure allows adjustments to be made based solely on the existing panel's connection relationship between 2M data lines Data in the spaces and the pixel circuits 2 in the circuit units 1, eliminating the need for additional adjustments to the spacing between circuit units 1 or the spacing between adjacent pixel circuits 2 in a circuit unit 1.

Further, referring to FIGS. 3A and 3B, to avoid the connection distance between the second pixel circuit 2-G and the data line Data being too long, two data lines Data connected to the second pixel circuit 2-G can be located between two data lines Data connected to the first pixel circuit 2-R and the first pixel circuit 2-R, or between two data lines Data connected to the third pixel circuit 2-B and the third pixel circuit 2-B.

Regarding the aforementioned design of "two data lines Data electrically connected to at least one pixel circuit 2 are located at a same side of the pixel circuit 2 in the first direction x," in another feasible embodiment, referring to FIGS. 4A and 4B, the pixel circuit 2 comprises a first side and a second side in the first direction x. Two data lines Data electrically connected to the pixel circuit 2 are located at the first side of the pixel circuit 2, and no other pixel circuits 2 are interposed between the data lines Data and the pixel circuit 2 connected thereto.

For example, the first data line Data1-R and the second data line Data2-R are located at a side of the first pixel circuit 2-R away from the second pixel circuit 2-G, and are adjacent to the first pixel circuit 2-R. The first data line Data1-G and the second data line Data2-G are located between the first pixel circuit 2-R and the second pixel circuit 2-G. The first data line Data1-B and the second data line Data2-B are located at a side of the third pixel circuit 2-B away from the second pixel circuit 2-G, and are adjacent to the third pixel circuit 2-B.

Based on this arrangement, in one aspect, three first connecting lines 3 connected to the circuit unit 1 do not overlap in the second direction y, and 2 × (k1+k2) of the vertical height above the circuit unit 1 can be compressed compared to the related art. Three second connecting lines 4 connected to the circuit unit 1 also do not overlap in the second direction y, and 2 × (k3+k4) of the vertical height below the circuit unit 1 can be compressed compared to the related art, so that the vertical height of the pixel can be compressed to a relatively small size, thereby achieving a relatively high PPI. In another aspect, each pixel circuit 2 is very close to two data lines Data connected thereto, and the corresponding connection distances are relatively small.

The first data line Data1 corresponding to each pixel circuit 2 is close to the pixel circuit 2 connected thereto, or the second data line Data corresponding to each pixel circuit 2 is close to the pixel circuit 2 connected thereto, so that the wiring of the connecting lines corresponding to different pixel circuits 2 is more regular.

In a feasible embodiment, referring to FIGS. 2A, 2B, and 5A-6B, two data lines Data electrically connected to at least one pixel circuit 2 are respectively located at opposite sides of the pixel circuit 2 in the first direction x.

In other words, for at least one of the pixel circuits 2, the areas at both sides of the pixel circuit 2 in the first direction x are each provided with one data line Data electrically connected to the pixel circuit 2. These two data lines Data can be adjacent to the pixel circuit 2 at both sides of the pixel circuit 2 or not, so as to realize flexible arrangement of the data lines Data.

Regarding the above-mentioned design of "two data lines Data electrically connected to at least one pixel circuit 2 are respectively located at opposite sides of the pixel circuit 2 in the first direction x", in a feasible embodiment, referring to FIGS. 2A, 2B, and 5A-6B, the pixel circuit 2 comprises a first pixel circuit 2-R, a second pixel circuit 2-G and a third pixel circuit 2-B.

The circuit unit 1 comprises a first pixel circuit 2-R, a second pixel circuit 2-G, and a third pixel circuit 2-B arranged in a first direction x.

Two data lines Data electrically connected to the second pixel circuit 2-G are respectively located at opposite sides of the second pixel circuit 2-G in the first direction x. The first data line Data1-G may be adjacent to or not adjacent to the second pixel circuit 2-G at one side of the second pixel circuit 2-G, and the second data line Data2-G may be adjacent to or not adjacent to the second pixel circuit 2-G at one side of the second pixel circuit 2-G.

The second pixel circuit 2-G is the central one of the pixel circuits 2 in the circuit unit 1. By adjusting the position of the data lines Data connected thereto, the number of first connecting lines 3 overlapping in the second direction y, and the number of second connecting lines 4 overlapping in the second direction y can be more directly changed. For example, referring to FIGS. 5A and 5B, in the case that two data lines Data connected to the second pixel circuit 2-G are located at both side of and adjacent to the second pixel circuit 2-G, three first connecting lines 3 do not overlap and three second connecting lines 4 do not overlap in the second direction y, thereby minimizing the vertical height of the pixel.

Regarding the above-mentioned design of "two data lines Data electrically connected to at least one pixel circuit 2 are respectively located at opposite sides of the pixel circuit 2 in the first direction x", in a feasible embodiment, referring to FIGS. 6A and 6B, two data lines Data electrically connected to the pixel circuit 2 are located at opposite sides of the pixel circuit 2 in the first direction x, and there is no other pixel circuit 2 between the data line Data and the pixel circuit 2 connected thereto.

That is, the first data line Data1-R and the second data line Data2-R are respectively located at opposite sides of the first pixel circuit 2-R in the first direction x and each are adjacent to the first pixel circuit 2-R. The first data line Data1-G and the second data line Data2-G are respectively located at opposite sides of the second pixel circuit 2-G in the first direction x and each are adjacent to the second pixel circuit 2-G. The first data line Data1-B and the second data line Data2-B are respectively located at opposite sides of the third pixel circuit 2-B in the first direction x and each are adjacent to the third pixel circuit 2-B.

In this arrangement, in one aspect, above the circuit unit 1, three first connecting lines 3 connected to the circuit unit 1 do not overlap in the second direction y, so that compared with the related art, 2 × (k1+k2) of the vertical height can be saved. Below the circuit unit 1, three second connecting lines 4 connected to the circuit unit 1 do not overlap in the second direction y either, so that compared with the related art, 2 × (k3+k4) of the vertical height can be saved, and the vertical height of the pixel can be compressed to a relatively small size. In another aspect, each pixel circuit 2 is very close to two data lines Data connected thereto, so that the connection and wiring are convenient, the connection distance is short, and the voltage drop is small. In yet another aspect, in this arrangement, two data lines Data are provided between two adjacent pixel circuits 2 in the first direction x, and the overall distribution of the data lines Data is more uniform.

In a feasible embodiment, referring to FIGS. 2A, 2B, 5A and 5B, the pixel circuit 2 comprises a first pixel circuit 2-R, a second pixel circuit 2-G and a third pixel circuit 2-B.

The circuit unit 1 comprises a first pixel circuit 2-R, a second pixel circuit 2-G, and a third pixel circuit 2-B arranged in a first direction x.

Two data lines Data electrically connected to the first pixel circuit 2-R are located at a side of the first pixel circuit 2-R away from the second pixel circuit 2-G, and two data lines Data electrically connected to the third pixel circuit 2-B are located at a side of the third pixel circuit 2-B away from the second pixel circuit 2-G. Two data lines Data electrically connected to the second pixel circuit 2-G are located at opposite sides of the second pixel circuit 2-G in the first direction x.

Based on the above arrangement of data lines, above the circuit unit 1, the first connecting lines 3 corresponding to the first pixel circuit 2-R and the third pixel circuit 2-B turn toward different sides to connect to the first data line Data1. The first connecting line 3 corresponding to the second pixel circuit 2-G either, as shown in FIGS. 2A and 2B, overlaps only the first connecting line 3 corresponding to the first pixel circuit 2-R (or the first connecting line 3 corresponding to the third pixel circuit 2-B) in the second direction y, thereby saving a vertical height of k1+k2 above the circuit unit 1 or, as shown in FIGS. 5A and 5B, does not overlap the first connecting line 3 corresponding to either the first pixel circuit 2-R or the third pixel circuit 2-B in the second direction y, thereby saving a vertical height of 2 × (k1+k2) above the circuit unit 1.

Below the circuit unit 1, the second connecting lines 4 corresponding to the first pixel circuit 2-R and the third pixel circuit 2-B turn toward different sides to connect to the second data line Data2. The second connecting line 4 corresponding to the second pixel circuit 2-G either, as shown in FIGS. 2A and 2B, overlaps only the second connecting line 4 corresponding to the first pixel circuit 2-R (or the second connecting line 4 corresponding to the third pixel circuit 2-B) in the second direction y, thereby saving a vertical height of k3+k4 below the circuit unit 1 or, as shown in FIGS. 5A and 5B, the second connecting lines 4 corresponding to the first pixel circuit 2-R and the third pixel circuit 2-B do not overlap in the second direction y, thereby saving a vertical height of 2 × (k3+k4) above the circuit unit 1.

Based on the above scheme, in a feasible embodiment, referring to FIGS. 5A and 5B, for two data lines Data electrically connected to the second pixel circuit 2-G, one is located between the first pixel circuit 2-R and the second pixel circuit 2-G, and the other is located between the second pixel circuit 2-G and the third pixel circuit 2-B.

For example, the first data line Data1-G is located between the first pixel circuit 2-R and the second pixel circuit 2-G, and the second data line Data2-G is located between the second pixel circuit 2-G and the third pixel circuit 2-B. Alternatively, the second data line Data2-G is located between the first pixel circuit 2-R and the second pixel circuit 2-G, and the first data line Data1-G is located between the second pixel circuit 2-G and the third pixel circuit 2-B.

In this arrangement, above the circuit unit 1, three first connecting lines 3 corresponding to three pixel circuits 2 do not overlap in the second direction y, and below the circuit unit 1, three second connecting lines 4 corresponding to three pixel circuits 2 also do not overlap in the second direction y. Compared to the related art, a vertical height of 2 × (k1+k2) + 2 × (k3+k4) of the pixels can be compressed.

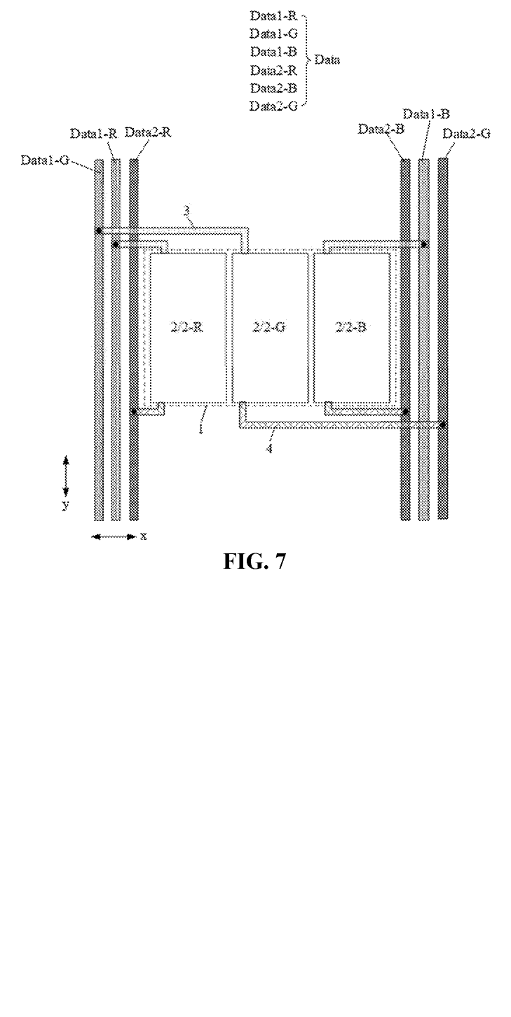

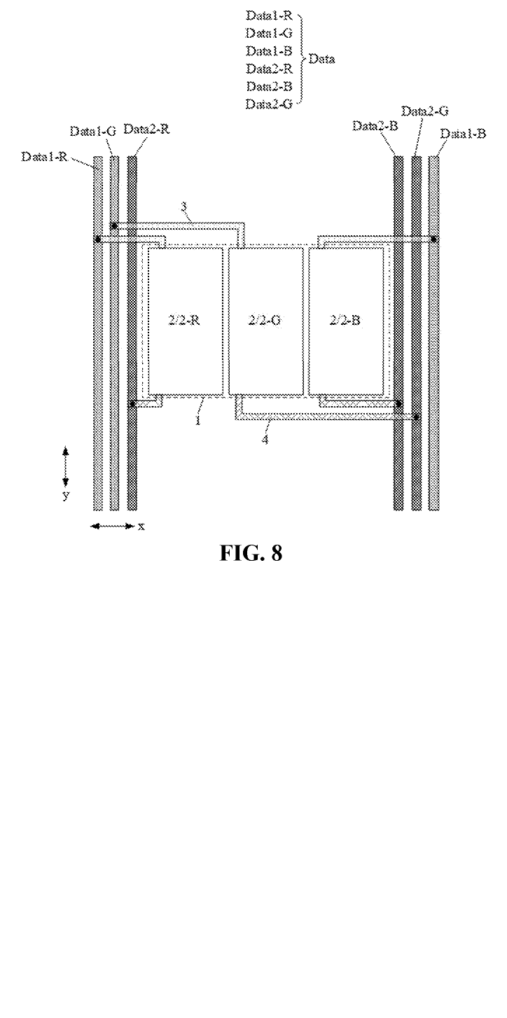

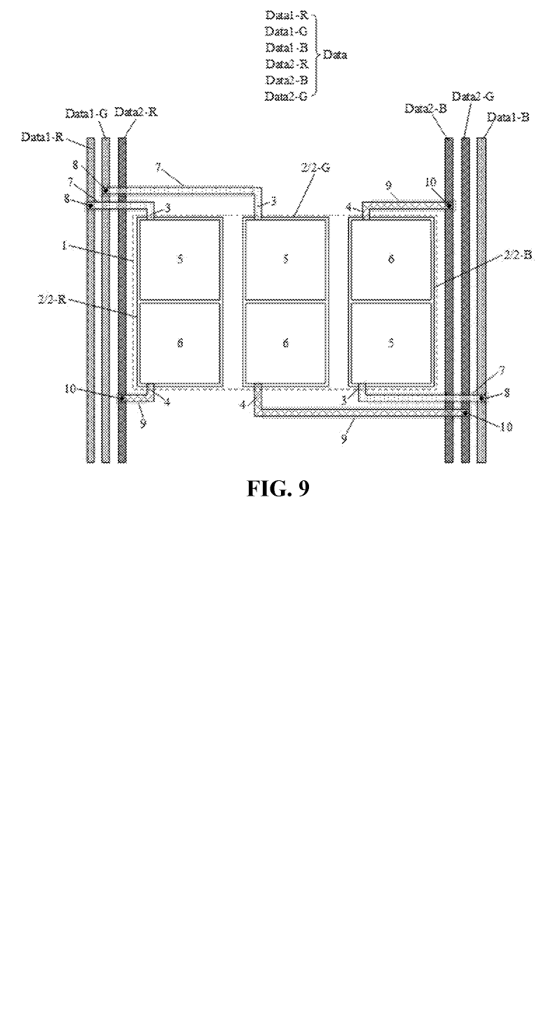

Alternatively, in another feasible embodiment, referring to FIGS. 2A and 2B, and as shown in FIGS. 7 and 8, FIG. 7 is a structural schematic diagram of the display panel provided in another embodiment of the present application, and FIG. 8 is a structural schematic diagram of the display panel provided in another embodiment of the present application. For two data lines Data electrically connected to the second pixel circuit 2-G, one is located at a side of the first pixel circuit 2-R away from the second pixel circuit 2-G, and the other is located at a side of the third pixel circuit 2-B away from the second pixel circuit 2-G.

For example, the first data line Data1-G is located at a side of the first pixel circuit 2-R away from the second pixel circuit 2-G, and the second data line Data2-G is located at a side of the third pixel circuit 2-B away from the second pixel circuit 2-G. Alternatively, the second data line Data2-G is located at a side of the first pixel circuit 2-R away from the second pixel circuit 2-G, and the first data line Data1-G is located at a side of the third pixel circuit 2-B away from the second pixel circuit 2-G.

Based on this arrangement, above the circuit unit 1, the first connecting line 3 corresponding to the second pixel circuit 2-G overlaps only the first connecting line 3 corresponding to the first pixel circuit 2-R (or the third pixel circuit 2-B) in the second direction y. Below the circuit unit 1, the second connecting line 4 corresponding to the second pixel circuit 2-G overlaps only the second connecting line 4 corresponding to the third pixel circuit 2-B (or the first pixel circuit 2-R) in the second direction y. Compared to the related art, this allows pixels to be compressed by a vertical height of k1+k2+k3+k4.

Further, referring to FIG. 8, one of two data lines Data electrically connected to the second pixel circuit 2-G is located between two data lines Data electrically connected to the first pixel circuit 2-R, and the other is located between two data lines Data electrically connected to the third pixel circuit 2-B.

For example, the first data line Data1-G is located between the first data line Data1-R and the second data line Data2-R, and the second data line Data2-G is located between the first data line Data1-B and the second data line Data2-B. Alternatively, the second data line Data2-G is located between the first data line Data1-R and the second data line Data2-R, and the first data line Data1-G is located between the first data line Data1-B and the second data line Data2-B.

Under the premise of compressing the vertical height of the pixel, this arrangement can shorten the connection distance between the second pixel circuit 2-G and the corresponding data line Data, thereby reducing the connection distance and the voltage drop.

Alternatively, referring to FIG. 2A, for two data lines Data electrically connected to the second pixel circuit 2-G, one is located between the first pixel circuit 2-R and two data lines Data electrically connected thereto, and the other is located between the third pixel circuit 2-B and two data lines Data electrically connected thereto.

For example, the first data line Data1-G is located between the first pixel circuit 2-R and two data lines, i.e., the first data line Data1-R and the second data line Data2-R, and the second data line Data2-G is located between the third pixel circuit 2-B and two data lines, i.e., the first data line Data1-B and the second data line Data2-B. Alternatively, the second data line Data2-G is located between the first pixel circuit 2-R and two data lines, i.e., the first data line Data1-R and the second data line Data2-R, and the first data line Data1-G is located between the third pixel circuit 2-B and two data lines, i.e., the first data line Data1-B and the second data line Data2-B.

Under the premise of compressing the vertical height of the pixel, this arrangement can shorten the connection distance between the second pixel circuit 2-G and the corresponding data line Data. The smaller the connection distance is, the smaller the corresponding signal voltage drop will be.

Alternatively, referring to FIG. 7, for two data lines Data electrically connected to the second pixel circuit 2-G, one is located at a side of two data lines Data electrically connected to the first pixel circuit 2-R away from the first pixel circuit 2-R, and the other is located at a side of two data lines Data electrically connected to the third pixel circuit 2-B away from the third pixel circuit 2-B.

For example, the first data line Data1-G is located at a side of the first data line Data1-R and the second data line Data2-R away from the first pixel circuit 2-R, and the second data line Data2-G is located at a side of the first data line Data1-B and the second data line Data2-B away from the third pixel circuit 2-B. Alternatively, the second data line Data2-G is located at a side of the first data line Data1-R and the second data line Data2-R away from the first pixel circuit 2-R, and the first data line Data1-G is located at a side of the first data line Data1-B and the second data line Data2-B away from the third pixel circuit 2-B.

Combined with the above analysis, this arrangement can save a vertical height of k1+k2 above the circuit unit 1, and a vertical height of k3+k4 below the circuit unit 1, thereby optimizing the layout design.

In the case that two data lines Data electrically connected to the first pixel circuit 2-R are located at a side of the first pixel circuit 2-R away from the second pixel circuit 2-G, two data lines Data electrically connected to the third pixel circuit 2-B are located at a side of the third pixel circuit 2-B away from the second pixel circuit 2-G, and two data lines Data electrically connected to the second pixel circuit 2-G are respectively located at opposite sides of the second pixel circuit 2-G in the first direction x. In a feasible embodiment, as shown in FIG. 9, which is a structural schematic diagram of the display panel provided in another embodiment of the present application, the pixel circuit 2 comprises a pulse amplitude modulation module 5 and a pulse width modulation module 6. The first data line Data1 is electrically connected to the pulse amplitude modulation module 5 through the first connecting line 3, and the second data line Data2 is electrically connected to the pulse width modulation module 6 through the second connecting line 4.

The first connecting line 3 comprises a first portion 7 extending at least in the first direction x, an end portion of the first portion is electrically connected to the first data line Data1 through a first via 8. The second connecting line 4 comprises a second portion 9 extending at least in the first direction x, an end portion of the second portion 9 is electrically connected to the second data line Data2 through a second via 10.

The first portion 7 and the second portion 9 corresponding to the pixel circuit 2 are respectively located at two opposite sides of the pixel circuit 2 in a second direction y intersecting with the first direction x.

The first portion 7 corresponding to the second pixel circuit 2-G and the first portion 7 corresponding to the first pixel circuit 2-R are located at a same side of the circuit unit 1 in the second direction y and overlap in the second direction y. The second portion 9 corresponding to the second pixel circuit 2-G and the first portion 7 corresponding to the third pixel circuit 2-B are located at a same side of the circuit unit 1 in the second direction y and overlap in the second direction y.

For example, the first portion 7 corresponding to the first pixel circuit 2-R is located above the circuit unit 1, and the first portion 7 corresponding to the third pixel circuit 2-B is located below the circuit unit 1.

The first data line Data1-G is located at a side of the first pixel circuit 2-R away from the second pixel circuit 2-G. The first connecting lines 3 corresponding to the first pixel circuit 2-R and the second pixel circuit 2-G both turn leftward above the circuit unit 1 to be electrically connected to the first data line Data1, so that the first portion 7 corresponding to the second pixel circuit 2-G and the first portion 7 corresponding to the first pixel circuit 2-R are both located above the circuit unit 1 and overlap in the second direction y.

The second data line Data2-G is located on a side of the third pixel circuit 2-B away from the second pixel circuit 2-G. The second connecting line 4 corresponding to the second pixel circuit 2-G turns rightward below the circuit unit 1 to be electrically connected to the second data line Data2. The first connecting line 3 corresponding to the third pixel circuit 2-B also turns rightward below the circuit unit 1 to be electrically connected to the first data line Data1. This causes the second portion 9 corresponding to the second pixel circuit 2-G and the first portion 7 corresponding to the third pixel circuit 2-B to be located below the circuit unit 1 and overlap in the second direction y.

Based on the above structure, the first data line Data1 and the first connecting line 3 transmit a PAM data voltage required for PAM driving, and the second data line Data2 and the second connecting line 4 transmit a PWM data voltage required for PWM driving. Typically, the PAM data voltage required for the same color sub-pixel at different grayscales is the same, and thus the first data line Data1 and the first connecting line 3 transmit a constant voltage signal.

With the above design, the first connecting line 3 corresponding to the second pixel circuit 2-G is adjacent to the first connecting line 3 corresponding to the first pixel circuit 2-R, and the second connecting line 4 corresponding to the second pixel circuit 2-G is adjacent to the first connecting line 3 corresponding to the third pixel circuit 2-B, thereby reducing interference with the connecting line corresponding to the second pixel circuit 2-G.

In one configuration, referring to FIG. 9, the positions of the pulse amplitude modulation module 5 and the pulse width modulation module 6 in the third pixel circuit 2-B can be swapped, that is, the pulse amplitude modulation module 5 in the third pixel circuit 2-B points to the direction of the pulse width modulation module 6, which is opposite to the direction in which the pulse amplitude modulation module 5 in the first pixel circuit 2-R and the second pixel circuit 2-G points to the pulse width modulation module 6, thereby making it easier to implement the above-mentioned technical solution.

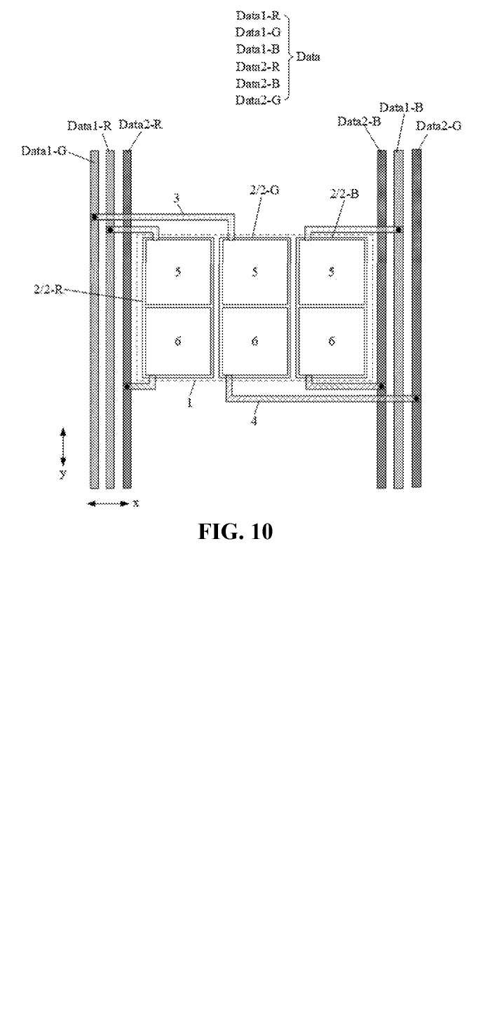

Exemplarily, two data lines Data electrically connected to the first pixel circuit 2-R are located at the side of the first pixel circuit 2-R away from the second pixel circuit 2-G, two data lines Data electrically connected to the third pixel circuit 2-B are located at the side of the third pixel circuit 2-B away from the second pixel circuit 2-G, and two data lines Data electrically connected to the second pixel circuit 2-G are respectively located at the opposite sides of the second pixel circuit 2-G in the first direction x. In this case, in a feasible embodiment, as shown in FIG. 10, which is a structural schematic diagram of the display panel provided in another embodiment of the present application, the pixel circuit 2 comprises a pulse amplitude modulation module 5 and a pulse width modulation module 6, the first data line Data1 is electrically connected to the pulse amplitude modulation module 5, and the second data line Data2 is electrically connected to the pulse width modulation module 6.

For two data lines Data electrically connected to the second pixel circuit 2-G, one is adjacent to the first data line Data1 electrically connected to the first pixel circuit 2-R, and the other is adjacent to the first data line Data1 electrically connected to the third pixel circuit 2-B.

For example, referring to FIG. 10, the first data line Data1-R is located at a side of the first data line Data1-R away from the second data line Data2-R and is adjacent to the first data line Data1-R, and the second data line Data2-R is located at a side of the first data line Data1-B away from the second data line Data2-B and is adjacent to the first data line Data1-B.

As previously mentioned, the first data line Data1 transmits a constant voltage signal in the case of electrically connected to the pulse amplitude modulation module 5. Therefore, by arranging two data lines Data connected to the second pixel circuit 2-G adjacent to the first data lines Data1 corresponding to the first pixel circuit 2-R and the third pixel circuit 2-B, mutual interference between the data lines Data can be reduced.

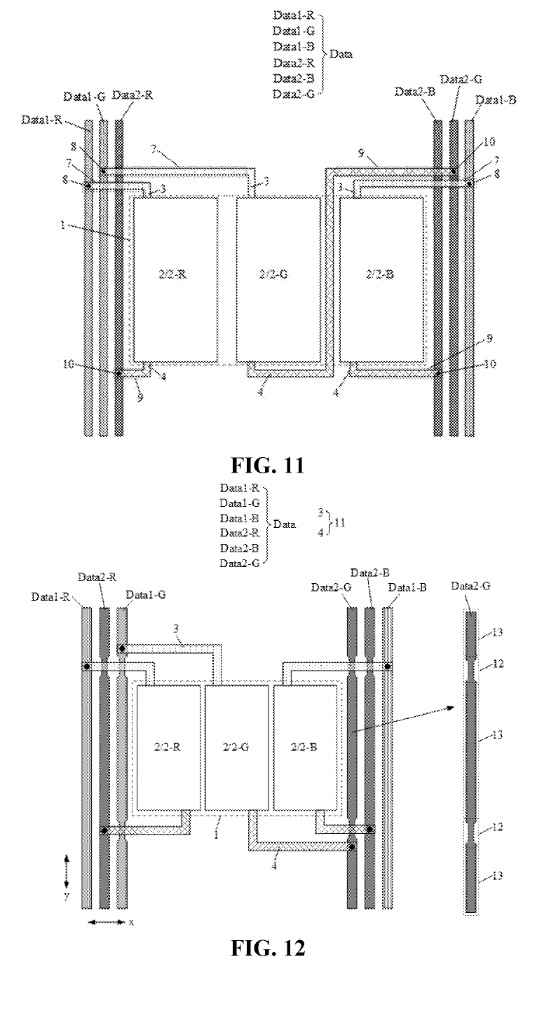

Exemplarily, two data lines Data electrically connected to the first pixel circuit 2-R are located at the side of the first pixel circuit 2-R away from the second pixel circuit 2-G, two data lines Data electrically connected to the third pixel circuit 2-B are located at the side of the third pixel circuit 2-B away from the second pixel circuit 2-G, and two data lines Data electrically connected to the second pixel circuit 2-G are respectively located at the opposite sides of the second pixel circuit 2-G in the first direction x. In this case, in a feasible embodiment, as shown in FIG. 11, which is a structural schematic diagram of the display panel provided by another embodiment of the present application, the pixel circuit 2 is electrically connected to the first data line Data1 through the first connecting line 3, and is electrically connected to the second data line Data2 through the second connecting line 4.

The first connecting line 3 comprises a first portion 7 extending at least in the first direction x, an end portion of the first portion being electrically connected to the first data line Data1 through a first via 8. The second connecting line 4 comprises a second portion 9 extending at least in the first direction x, an end portion of the second portion 9 being electrically connected to the second data line Data2 through a second via 10.

The first portion 7 and the second portion 9 corresponding to the second pixel circuit 2-G are located at the same side of the circuit unit 1 in the second direction y intersecting with the first direction x.

For example, referring to FIG. 11, the first portion 7 and the second portion 9 corresponding to the second pixel circuit 2-G are both located above the circuit unit 1. After led out below the circuit unit 1, the second connecting line 4 corresponding to the second pixel circuit 2-G can extend upward between the second pixel circuit 2-G and the third pixel circuit 2-B to the upper side of the circuit unit 1, and then can turn rightward to be electrically connected to the second data line Data2.

This structure can further compress some layout space below (or above) the circuit unit 1, and the vertical height of the pixel is smaller, so that more pixels can be provided in a limited space to achieve a higher PPI.

In a feasible embodiment, as shown in FIG. 12, which is a structural schematic diagram of the display panel provided by another embodiment of the present application, the pixel circuit 2 is electrically connected to the data line Data through a connecting line 11.

At least one of the data lines Data comprises a first line segment 12 and a second line segment 13. In a direction perpendicular to the plane where the display panel is located, the first line segment 12 overlaps the connecting line 11 connected to other data lines Data, and the second line segment 13 does not overlap the connecting line 11 connected to other data lines Data.

The connecting line 11 comprises a first connecting line 3 and a second connecting line 4. The overlapping of the first line segment 12 and the connecting line 11 connected to other data lines Data means that the first line segment 12 and the first connecting line 3 or the second connecting line 4 connected to other data lines Data overlap.

The above configuration is to perform necking processing on the data line Data. By reducing the line width of the first line segment 12, the overlapping area between the first line segment 12 and the connecting line 11 connected to other data lines Data can be reduced, thereby reducing coupling.

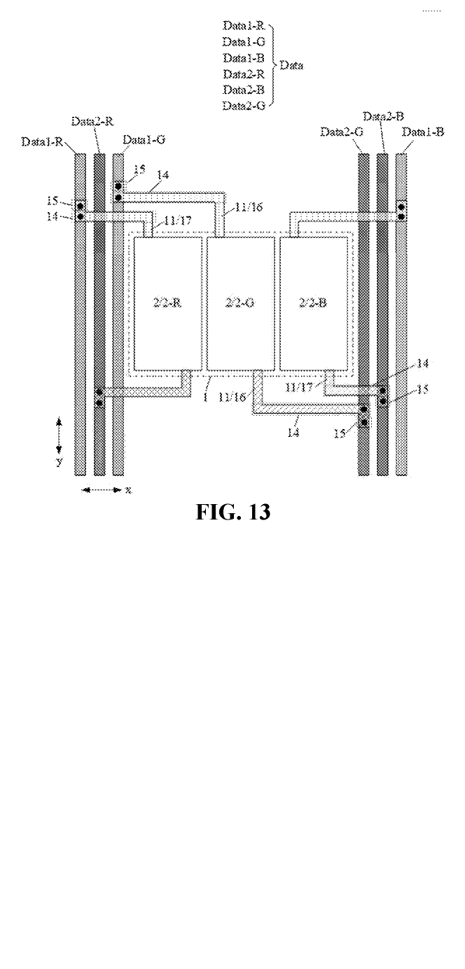

In a feasible embodiment, as shown in FIG. 13, which is a structural diagram of a display panel provided by another embodiment of the present application, the pixel circuit 2 is electrically connected to the data line Data through a connecting line 11.

The connecting line 11 comprises a first sub-portion 14 and a second sub-portion 15 that are connected. At least a part of the first sub-portion 14 extends in a first directionx, and the second sub-portion 15 protrudes from the first sub-portion 14 in a second direction y. In a direction perpendicular to the plane where the display panel is located, the second sub-portion 15 overlaps the data line Data connected thereto, the second direction y intersecting with the first direction x.

The connecting line 11 comprises a first connecting sub-line 16 and a second connecting sub-line 17, the first sub-portions 14 of the first connecting sub-line 16 and the second connecting sub-line 17 are located at the same side of the circuit unit 1 in the second direction y, and, in the second direction y, the second sub-portion 15 of the first connecting sub-line 16 overlaps the first sub-portion 14 of the second connecting sub-line 17.

The second sub-portion 15 of the first connecting sub-line 16 protrudes from the first sub-portion 14 in a direction away from the second connecting sub-line 17.

The second sub-portion 15 is provided in the connecting line 11, which can increase the overlapping area between the connecting line 11 and the data line Data connected thereto, and further, at least two vias can be provided at the end portion of the connecting line 11 to connect to the data line Data, thereby improving the connection reliability between the pixel circuit 2 and the data line Data.

For the first connecting sub-line 16 and the second connecting sub-line 17, if the second sub-portion 15 in the first sub-connecting line 16 protrudes from the first sub-portion 14 in the direction close to the second sub-connecting line 17, then the interval between the first sub-portions 14 in the first connecting sub-line 16 and the second connecting sub-line 17 in the second direction y needs to be relatively large to accommodate the second sub-portion 15 of the first connecting sub-line 16. In the embodiments of the present application, the second sub-portion 15 in the first sub-connecting line 16 protrudes from the first sub-portion 14 in a direction away from the second sub-connecting line 17. With this arrangement, the interval between the first sub-portions 14 in the first sub-connecting line 16 and the second sub-connecting line 17 in the second direction y does not need to accommodate the second sub-portion 15. The released space can be used to compress the spacing between the first sub-portions 14 in the first connecting sub-line 16 and the second connecting sub-line 17 to reduce the vertical height of the pixel, or it can also be used to increase the width of the first sub-portion 14 in the first connecting sub-line 16 or the second connecting sub-line 17 to balance the load of the first connecting sub-line 16 and the second connecting sub-line 17.

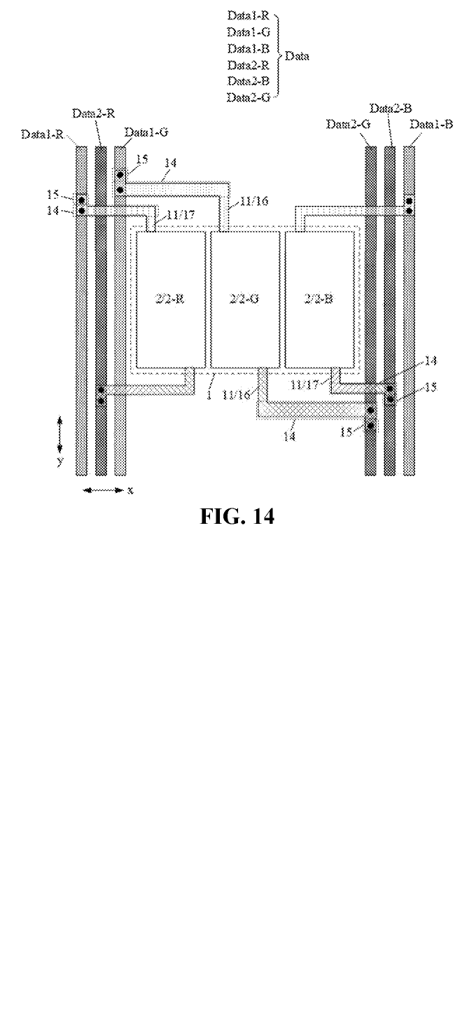

For example, as shown in FIG. 14, which is a structural schematic diagram of a display panel provided in another embodiment of the present application, the length of the first sub-portion 14 in the first connecting sub-line 16 is greater than the length of the first sub-portion 14 in the second connecting sub-line 17, and the width of the first sub-portion 14 in the first connecting sub-line 16 in the second direction y is greater than the width of the first sub-portion 14 in the second connecting sub-line 17 in the second direction y. Alternatively, the length of the first sub-portion 14 in the second connecting sub-line 17 is greater than the length of the first sub-portion 14 in the first connecting sub-line 16, and the width of the first sub-portion 14 in the second connecting sub-line 17 in the second direction y is greater than the width of the first sub-portion 14 in the first connecting sub-line 16 in the second direction y, thereby balancing the loads of the first connecting sub-line 16 and the second connecting sub-line 17.

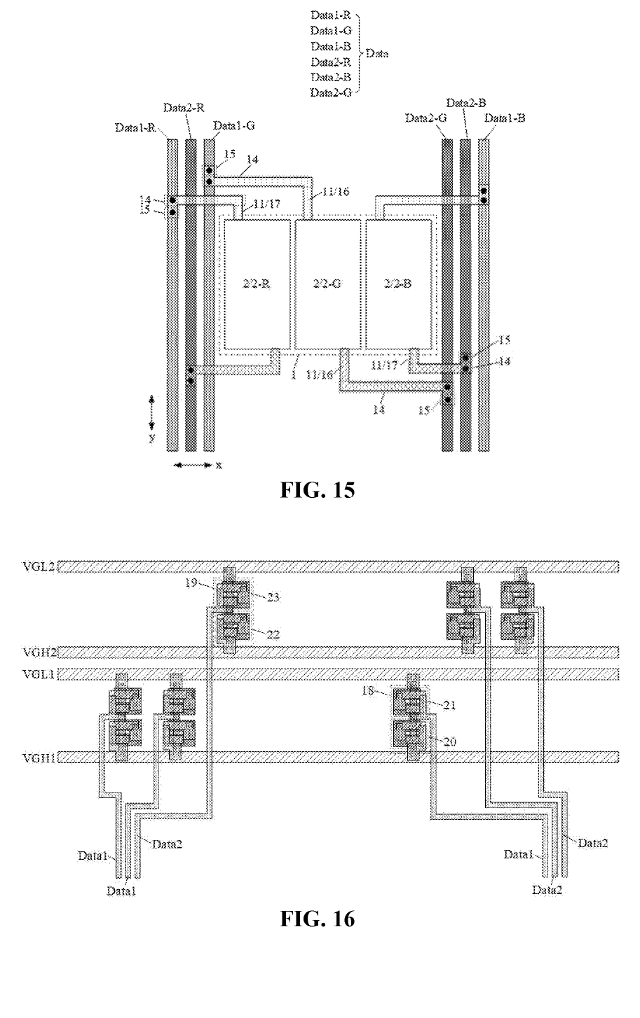

Furthermore, as shown in FIG. 15, which is a schematic structural diagram of a display panel provided in another embodiment of the present application, the second sub-portion 15 in the second connecting sub-line 17 points in the direction of the first sub-portion 14, which is opposite to the direction in which the second sub-portion 15 in the first connecting sub-line 16 points to the first sub-portion 14. That is, the second sub-portions 15 in the first connecting sub-line 16 and the second sub-portion 15 in the second connecting sub-line 17 face away from each other, which can prevent the second sub-portion 15 in the second sub-connecting line 17 from overlapping the first sub-connecting line 16 in the first direction x, thereby reducing coupling between two connecting lines.

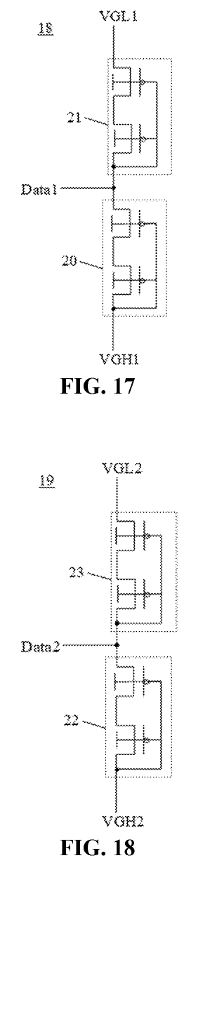

In a feasible embodiment, as shown in FIGS. 16-18, FIG. 16 is a structural schematic diagram of the display panel provided in another embodiment of the present application, FIG. 17 is a circuit structural schematic diagram of a first electrostatic protection circuit 18 provided in an embodiment of the present application, and FIG. 18 is a circuit structural schematic diagram of a second electrostatic protection circuit 19 provided in an embodiment of the present application. The display panel further comprises a first electrostatic protection circuit 18 and a second electrostatic protection circuit 19.

The first electrostatic protection circuit 18 is electrically connected to the first data line Data1, a first high potential signal line VGH1, and a first low potential signal line VGL1 respectively. The second electrostatic protection circuit 19 is electrically connected to the second data line Data2, a second high potential signal line VGH2, and a second low potential signal line VGL2 respectively.

The first high potential signal line VGH1 and the second high potential signal line VGH2 provide different voltages. Additionally or alternatively, the first low potential signal line VGL1 and the second low potential signal line VGL2 provide different voltages.

In one configuration, the first electrostatic protection circuit 18 comprises a first switch 20 and a second switch 21. A control terminal and a first terminal of the first switch 20 are electrically connected to the first high-voltage signal line VGH1, and a second terminal of the first switch 20 is electrically connected to the first data line Data1. A control terminal and a first terminal of the second switch 21 are electrically connected to the first data line Data1, and a second terminal of the second switch 21 is electrically connected to the first low-voltage signal line VGL1. When static electricity causes a voltage abnormality on the first data line Data1, if the voltage is too high, the first switch 20 turns on, and the static electricity is conducted away through the first high-voltage signal line VGH1; if the voltage is too low, the second switch 21 turns on, and the static electricity is conducted away through the first low-voltage signal line VGL1, thereby providing electrostatic protection for the first data line Data1.

The second electrostatic protection circuit 19 comprises a third switch 22 and a fourth switch 23. A control terminal and a first terminal of the third switch 22 are electrically connected to the second high-potential signal line VGH2, and a second terminal of the third switch 22 is electrically connected to the second data line Data2. A control terminal and a first terminal of the fourth switch 23 are electrically connected to the second data line Data2, and a second terminal of the fourth switch 23 is electrically connected to the second low-potential signal line VGL2. When static electricity causes the voltage on the second data line Data2 to become abnormal, if the voltage is too high, the third switch 22 turns on, and the static electricity is conducted away through the second high-potential signal line VGH2, if the voltage is too low, the fourth switch 23 turns on, and the static electricity is conducted away through the second low-potential signal line VGL2.

In the configuration of the pixel circuit 2 that combines PAM and PWM drive, the pulse width modulation module 6 needs to charge the gate of the driving transistor in the pulse amplitude modulation module 5. Therefore, under normal circumstances, the PWM data voltage is higher than the PAM data voltage. For example, the voltage range of the PWM data voltage is 0 to 5 V, and the voltage range of the PAM data voltage is -5 V to 0 V. Therefore, when designing the electrostatic protection circuit for the first data line Data1 and the second data line Data2, the high-level voltage and low-level voltage received by the two electrostatic protection circuits can be designed differently to better match the voltage range of the connected data line Data, thereby providing better electrostatic protection for the connected data line Data.

For example, the first data line Data1 is used to provide a PAM data voltage, and the voltages provided by the first high-potential signal line VGH1 and the first low-potential signal line VGL1 are designed to be +3 V and -12 V, respectively. The second data line Data2 is used to provide a PWM data voltage, and the voltages provided by the second high-potential signal line VGH2 and the second low-potential signal line VGL2 are designed to be +8 V and -7 V, respectively.

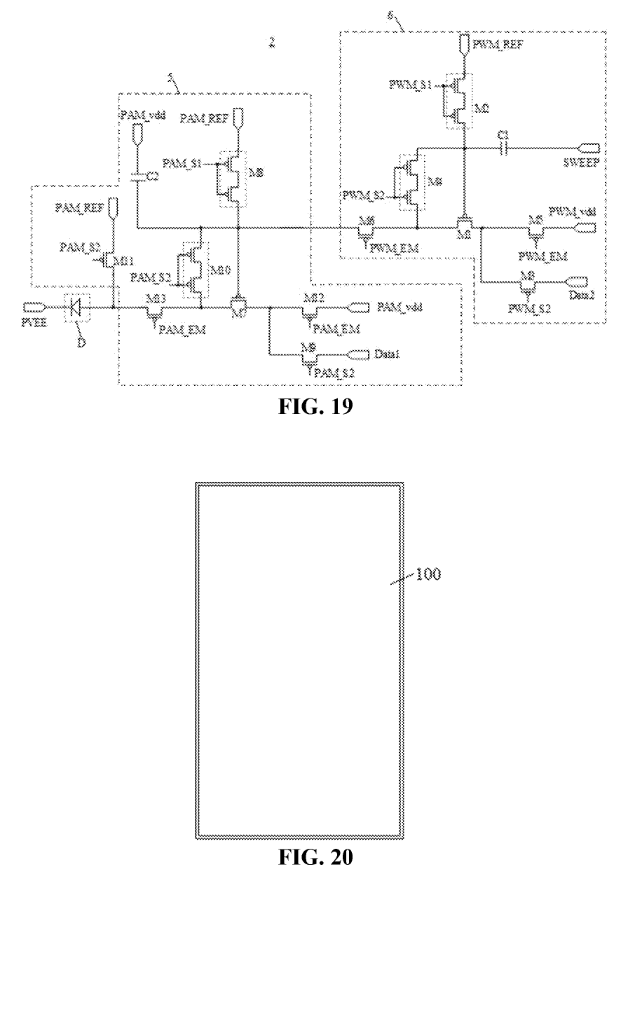

Taking the pixel circuit 2 shown in FIG. 19 as an example, the circuit configuration of the pixel circuit 2 is schematically illustrated below.

As shown in FIG. 19, which is a circuit structure diagram of the pixel circuit 2 provided in an embodiment of the present application, the pixel circuit 2 comprises a pulse width modulation module 6 and a pulse amplitude modulation module 5. The first data line Data1 is electrically connected to the pulse amplitude modulation module 5, and the second data line Data2 is electrically connected to the pulse width modulation module 6.

The pulse width modulation module 6 may comprise:

a first driving transistor M1;

a first gate reset transistor M2, a gate of the first gate reset transistor M2 being electrically connected to the first scan line PWM-S1, a first electrode of the first gate reset transistor M2 being electrically connected to the first reset signal line PWM-REF, and a second electrode of the first gate reset transistor M2 being electrically connected to the gate of the first driving transistor M1;

a writing transistor M3, a gate of the writing transistor M3 being electrically connected to the second scan line PWM-S2, a first electrode of the writing transistor M3 being electrically connected to the second data line Data2, and a second electrode of the writing transistor M3 being electrically connected to the first electrode of the first driving transistor M1;

a first compensation transistor M4, a gate of the first compensation transistor M4 being electrically connected to the second scan line PWM-S2, a first electrode of the first compensation transistor M4 being electrically connected to the second electrode of the first driving transistor M1, and a second electrode of the first compensation transistor M4 being electrically connected to the gate of the first driving transistor M1;

a first capacitor C1, a first plate of the first capacitor C1 being electrically connected to a sweep signal line SWEEP, and a second plate of the first capacitor C1 being electrically connected to the gate of the first driving transistor M1;

a first light emitting control transistor M5, a gate of the first light emitting control transistor M5 being electrically connected to a first light emitting control signal line PWM-EM, a first electrode of the first light emitting control transistor M5 being electrically connected to a first fixed potential signal line PWM-vdd, and a second electrode of the first light emitting control transistor M5 being electrically connected to the first electrode of the first driving transistor M1; and

a second light emitting control transistor M6, a gate of the second light emitting control transistor M6 being electrically connected to the first light emitting control signal line PWM-EM, and a first electrode of the second light emitting control transistor M6 being electrically connected to the second electrode of the first driving transistor M1.

The pulse amplitude modulation module 5 may comprise:

a second driving transistor M7, a gate of the second driving transistor M7 being electrically connected to the second electrode of the second light emitting control transistor M6;

a second gate reset transistor M8, a gate of the second gate reset transistor M8 being electrically connected to a third scan line PAM-S1, a first electrode of the second gate reset transistor M8 being electrically connected to a second reset signal line PAM-REF, and a second electrode of the second gate reset transistor M8 being electrically connected to the gate of the second driving transistor M7;

a second data writing transistor M9, a gate of the second data writing transistor M9 being electrically connected to a fourth scan line PAM-S2, a first electrode of the second data writing transistor M9 being electrically connected to the first data line Data1, and a second electrode of the second data writing transistor M9 being electrically connected to the first electrode of the second driving transistor M7;

a second compensation transistor M10, a gate of the second compensation transistor M10 being electrically connected to the fourth scan line PAM-S2, a first electrode of the second compensation transistor M10 being electrically connected to the second electrode of the second driving transistor M7, and a second electrode of the second compensation transistor M10 being electrically connected to the gate of the second driving transistor M7;

an anode reset transistor M11, a gate of the anode reset transistor M11 being electrically connected to the fourth scan line PAM-S2, a first electrode of the anode reset transistor M11 being electrically connected to the second reset signal line PAM-REF, and a second electrode of the anode reset transistor M11 being electrically connected to the light emitting element D;

a third light emitting control transistor M12, a gate of the third light emitting control transistor M12 being electrically connected to the second light emitting control transistor PAM-EM, a first electrode of the third light emitting control transistor M12 being electrically connected to the second fixed potential signal line PAM-vdd, and a second electrode of the third light emitting control transistor M12 being electrically connected to the first electrode of the second driving transistor M7;

a fourth light emitting control transistor M13, a gate of the fourth light emitting control transistor M13 being electrically connected to the second light emitting control transistor PAM-EM, a first electrode of the fourth light emitting control transistor M13 being electrically connected to the second electrode of the second driving transistor M7, and a second electrode of the fourth light emitting control transistor M13 being electrically connected to the light emitting element D; and

a second capacitor C2, a first plate of the second capacitor C2 being electrically connected to the second fixed potential signal line PAM-vdd, and a second plate of the second capacitor C2 being electrically connected to the gate of the second driving transistor M7.

It should be noted that FIG. 19 is only a schematic diagram of one circuit structure of the pixel circuit 2. In other optional embodiments of the present application, the pixel circuit 2 may also be in other forms.

Based on the same inventive concept, embodiments of the present application further provides a display device, as shown in FIG. 20, which is a schematic structural diagram of a display device provided by an embodiment of the present application, the display device comprises the above-mentioned display panel 100. Of course, the display device shown in FIG. 20 is merely for illustration, and the display device can be any electronic device with a display function, such as a mobile phone, a tablet computer, a laptop computer, an e-reader, or a television.

The above description are only preferred embodiments of the present application and not intended to limit the present application. Any modifications, equivalent substitutions, improvements, etc. made within the spirit and principles of the present application should be comprised in the scope of protection of the present application.

Finally, it should be noted that the above embodiments are only used to illustrate the technical solutions of the present application, rather than to limit it. Although the present application has been described in detail with reference to the above embodiments, those skilled in the art should understand that they can still modify the technical solutions described in the above embodiments, or replace some or all of the technical features therein with equivalents. However, these modifications or replacements do not cause the essence of the corresponding technical solutions to deviate from the scope of the technical solutions of the embodiments of the present application.

What is claimed is:

1. A display panel, comprising:
circuit units, a circuit unit of the circuit units comprising M pixel circuits arranged in a first direction, where M is an integer greater than or equal to 2; and
data lines comprising first data lines and second data lines, the pixel circuits being electrically connected to the data lines,
wherein the data lines adjacent to each other in the first direction and not separated by any one of the pixel circuits comprise at most M-1 ones of the first data lines electrically connected to the circuit unit, and/or at most M-1 ones of the second data lines electrically connected to the circuit unit; or
at both of two opposite sides of at least one of the pixel circuits in the first direction, at least one of the first data lines electrically connected to the circuit unit in which the at least one pixel circuit is located and at least one of the second data lines electrically connected to the circuit unit in which the at least one pixel circuit is located are disposed.

2. The display panel according to claim 1, wherein
in the first direction, none of the circuit units is interposed between the data lines and the circuit unit electrically connected thereto.

3. The display panel according to claim 1, wherein
in the circuit unit, the first data lines electrically connected to at most M-1 ones of the pixel circuits are located at a same side of the circuit unit in the first direction, and the second data lines electrically connected to at most M-1 ones of the pixel circuits are located at a same side of the circuit unit in the first direction.

4. The display panel according to claim 1, wherein
two of the data lines electrically connected to a pixel circuit of the pixel circuits are located at a same side of the pixel circuit in the first direction.

5. The display panel according to claim 4, wherein
the pixel circuits comprise a first pixel circuit, a second pixel circuit, and a third pixel circuit;
the circuit unit comprises the first pixel circuit, the second pixel circuit, and the third pixel circuit arranged in the first direction;
two of the data lines electrically connected to the first pixel circuit are located at a side of the first pixel circuit away from the second pixel circuit, and/or two of the data lines electrically connected to the third pixel circuit are located at a side of the third pixel circuit away from the second pixel circuit.

6. The display panel according to claim 5, wherein
two of the data lines electrically connected to the second pixel circuit are located at a same side of the circuit unit in the first direction.

7. The display panel according to claim 4, wherein
the pixel circuit comprises a first side and a second side in the first direction;
the two of the data lines electrically connected to the pixel circuit are located at the first side of the pixel circuit, and no other pixel circuit of the pixel circuits is interposed between the pixel circuit and the data lines connected thereto.

8. The display panel according to claim 1, wherein
two of the data lines electrically connected to a pixel circuit of the pixel circuits are respectively located at two opposite sides of the at least one pixel circuit in the first direction; or
the pixel circuits comprise a first pixel circuit, a second pixel circuit, and a third pixel circuit, the circuit unit comprises the first pixel circuit, the second pixel circuit, and the third pixel circuit arranged in the first direction, and two of the data lines electrically connected to the second pixel circuit are respectively located at two opposite sides of the second pixel circuit in the first direction.

9. The display panel according to claim 8, wherein
the two of the data lines electrically connected to a pixel circuit of the pixel circuits are located at opposite sides of the pixel circuit in the first direction, and for the two data lines, no other pixel circuit of the pixel circuits is interposed between the pixel circuit and the data lines connected thereto.

10. The display panel according to claim 1, wherein
the pixel circuits comprise a first pixel circuit, a second pixel circuit, and a third pixel circuit;
the circuit unit comprises the first pixel circuit, the second pixel circuit, and the third pixel circuit arranged in the first direction;
two of the data lines electrically connected to the first pixel circuit are located at a side of the first pixel circuit away from the second pixel circuit, and two of the data lines electrically connected to the third pixel circuit are located at a side of the third pixel circuit away from the second pixel circuit;
two of the data lines electrically connected to the second pixel circuit are respectively located at two opposite sides of the second pixel circuit in the first direction.

11. The display panel according to claim 10, wherein
for the two data lines electrically connected to the second pixel circuit, one of the two data lines is located between the first pixel circuit and the second pixel circuit, and the other one of the two data lines is located between the second pixel circuit and the third pixel circuit.

12. The display panel according to claim 10, wherein
for the two data lines electrically connected to the second pixel circuit, one of the two data lines is located at a side of the first pixel circuit away from the second pixel circuit, and the other one of the two data lines is located at a side of the third pixel circuit away from the second pixel circuit; or
for the two data lines electrically connected to the second pixel circuit, one of the two data lines is located between the two data lines electrically connected to the first pixel circuit, and the other one of the two data lines is located between the two data lines electrically connected to the third pixel circuit; or
for the two data lines electrically connected to the second pixel circuit, one of the two data lines is located between the first pixel circuit and the two data lines electrically connected to the first pixel circuit, and the other one of the two data lines is located between the third pixel circuit and the two data lines electrically connected to the third pixel circuit; or
for the two data lines electrically connected to the second pixel circuit, one of the two data lines is located at a side of the two data lines electrically connected to the first pixel circuit away from the first pixel circuit, and the other one of the two data lines is located at a side of the two data lines electrically connected to the third pixel circuit away from the third pixel circuit.

13. The display panel according to claim 12, wherein
at least one of the pixel circuits comprises a pulse amplitude modulation module electrically connected to one of the first data lines through a first connecting line, and a pulse width modulation module electrically connected to one of the second data lines through a second connecting line,
the first connecting line comprises a first portion extending at least in the first direction, an end portion of the first portion being electrically connected to one of the first data lines through a first via, the second connecting line comprises a second portion extending at least in the first direction, an end portion of the second portion being electrically connected to one of the second data lines through a second via, the first portion and the second portion corresponding to one of the pixel circuits being respectively located at two opposite sides of the pixel circuit in a second direction intersecting with the first direction, the first portion corresponding to the second pixel circuit and the first portion corresponding to the first pixel circuit being located at a same side of the circuit unit in the second direction and overlap in the second direction, and the second portion corresponding to the second pixel circuit and the first portion corresponding to the third pixel circuit being located at a same side of the circuit unit in the second direction and overlap in the second direction; or
at least one of the pixel circuits is electrically connected to one of the first data lines through a first connecting line and is electrically connected to one of the second data lines through a second connecting line,
the first connecting line comprises a first portion extending at least in the first direction, an end portion of the first portion being electrically connected to one of the first data lines through a first via, the second connecting line comprises a second portion extending at least in the first direction, an end portion of the second portion being electrically connected to one of the second data lines through a second via, and the first portion and the second portion corresponding to the second pixel circuit being located at a same side of the circuit unit in a second direction intersecting with the first direction.

14. The display panel according to claim 12, wherein
at least one of the pixel circuits comprises a pulse amplitude modulation module electrically connected to one of the first data lines and a pulse width modulation module electrically connected to one of the second data lines;
for the two data lines electrically connected to the second pixel circuit, one of the two data lines is adjacent to the first data line electrically connected to the first pixel circuit, and the other one of the two data lines is adjacent to the first data line electrically connected to the third pixel circuit.

15. The display panel according to claim 1, wherein
at least one of the pixel circuits is electrically connected to one of the data lines through a connecting line;
at least one of the data lines comprise a first line segment and a second line segment, in a direction perpendicular to a plane where the display panel is located, the first line segment overlapping the connecting line connected to other data lines of the data lines, and a line width of the first line segment being smaller than a line width of the second line segment.

16. The display panel according to claim 1, wherein
at least one of the pixel circuits is electrically connected to one of the data lines through a connecting line;
the connecting line comprises a first sub-portion and a second sub-portion that are connected to each other, at least a part of the first sub-portion extending in the first direction, the second sub-portion protruding from the first sub-portion in a second direction intersecting with the first direction, and in a direction perpendicular to a plane where the display panel is located, the second sub-portion overlapping the data line connected thereto;
the connecting line comprises a first connecting sub-line and a second connecting sub-line, the first sub-portions of the first connecting sub-line and the second connecting sub-line are located at a same side of the circuit unit in the second direction, and in the second direction, the second sub-portion of the first connecting sub-line overlaps the first sub-portion of the second connecting sub-line;
the second sub-portion of the first connecting sub-line protrudes from the first sub-portion in a direction away from the second connecting sub-line.

17. The display panel according to claim 16, wherein
a direction in which the second sub-portion of the second connecting sub-line points to the first sub-portion of the second connecting sub-line is opposite to a direction in which the second sub-portion of the first connecting sub-line points to the first sub-portion of the first connecting sub-line.

18. The display panel according to claim 16, wherein
a length of the first sub-portion of the second connecting sub-line is greater than a length of the first sub-portion of the first connecting sub-line, and a width of the first sub-portion of the second connecting sub-line in the second direction is greater than a width of the first sub-portion of the first connecting sub-line in the second direction; or
a length of the first sub-portion of the first connecting sub-line is greater than a length of the first sub-portion of the second connecting sub-line, and a width of the first sub-portion of the first connecting sub-line in the second direction is greater than a width of the first sub-portion of the second connecting sub-line in the second direction.

19. The display panel according to claim 1, wherein
the display panel further comprises a first electrostatic protection circuit and a second electrostatic protection circuit;
the first electrostatic protection circuit is electrically connected to one of the first data lines, a first high-potential signal line, and a first low-potential signal line, and the second electrostatic protection circuit is electrically connected to one of the second data lines, a second high-potential signal line, and a second low-potential signal line;
voltages provided by the first high-potential signal line and the second high-potential signal line are different, and/or voltages provided by the first low-potential signal line and the second low-potential signal line are different.

20. A display device, comprising a display panel comprising:
circuit units, a circuit unit of the circuit units comprising M pixel circuits arranged in a first direction, where M is an integer greater than or equal to 2; and
data lines comprising first data lines and second data lines, the pixel circuits being electrically connected to the data lines,
wherein the data lines adjacent to each other in the first direction and not separated by any one of the pixel circuits comprise at most M-1 ones of the first data lines electrically connected to the circuit unit, and/or at most M-1 ones of the second data lines electrically connected to the circuit unit; or
at both of two opposite sides of at least one of the pixel circuits in the first direction, at least one of the first data lines electrically connected to the circuit unit in which the at least one pixel circuit is located and at least one of the second data lines electrically connected to the circuit unit in which the at least one pixel circuit is located are disposed.
